(19) United States
(12) Patent Application Publication
(10) Pub. No.: US 2025/0238517 A1
(43) Pub. Date: Jul. 24, 2025

(54) INSTANTANEOUS VULNERABILITY NOTIFICATION IN KUBERNETES

(71) Applicant: Dell Products L.P., Round Rock, TX (US)

(72) Inventors: Raveendra Babu Madala, Bangalore (IN); Santosh Gore, Bangalore (IN); Parmeshwr Prasad, Bangalore (IN)

(21) Appl. No.: 18/417,322

(22) Filed: Jan. 19, 2024

(51) Int. Cl. G06F 21/57

(52) U.S. Cl. CPC G06F 21/577; G06F 2221/034

(57) ABSTRACT

One example method includes monitoring a containerized workload environment, receiving, as a result of the monitoring, a trigger indicating that a system in the containerized workload environment should be modified to address a vulnerability of the system, as a result of the trigger, updating a vulnerability compliance resource catalogue, associated with the system, to list an update that is needed to address the vulnerability, implementing the update in the system, performing a reconciliation that comprises identifying the system as needing a vulnerability compliance calculation, and performing the vulnerability compliance calculation for the system and generating, based on the performing, a vulnerability compliance score for the system.

### FIELD OF THE INVENTION

Embodiments of the present invention generally relate to identifying, and dealing with, vulnerabilities in containerized workload execution environments. More particularly, at least some embodiments of the invention relate to systems, hardware, software, computer-readable media, and methods, for automatically identifying system vulnerabilities, such as in containerized environments, and notifying, possibly instantaneously, administrators concerning those vulnerabilities, as well as identifying responsive actions, and evaluating vulnerability compliance.

### BACKGROUND

Information technology is being used to solve a variety of problems in a variety of fields. Data centers enable information technology solutions to be made available to end users. Data centers are growing at a rapid pace to facilitate the non-stop availability of solutions to end-users. Each of the solutions might require a specific operating environment.

For example, data centers are expected to provide the operating environment as needed so that solution needs are met on demand. To serve the ever-growing data center operating environment preparation needs, automated operating environment preparation is needed. Data center providers are widely adopting web services for providing infrastructure as a service and platform as a service for various solutions due to the inherent geographic distribution of data centers.

To address solution scaling needs, infrastructure providers need to quickly transfer systems from supporting one solution, to another. Kubernetes, for example, is a portable, extensible, open-source platform for managing containerized workloads and services that facilitates both declarative configuration and automation. Several infrastructure providers have adopted Kubernetes. However, Kubernetes does not provide comprehensive machine configuration, maintenance, management, or self-healing systems. Though web services exist to perform operating environment preparation and management tasks, using them natively in Kubernetes requires significant administrative attention, and may not be effective.

Because security is a top priority for system administrators, they are required to consider responding to most system security advisories. System administrators typically manage vulnerabilities using systems management software and/or some type of manual approach. The administrators configure the system management software to notify them of new vulnerabilities, and other circumstances. However, as organizations adopt Kubernetes and focus on app orchestration, the lack of mechanisms for dealing with problems makes the environment vulnerable.

### BRIEF DESCRIPTION OF THE DRAWINGS

In order to describe the manner in which at least some of the advantages and features of the invention may be obtained, a more particular description of embodiments of the invention will be rendered by reference to specific embodiments thereof which are illustrated in the appended drawings. Understanding that these drawings depict only typical embodiments of the invention and are not therefore to be considered to be limiting of its scope, embodiments of the invention will be described and explained with additional specificity and detail through the use of the accompanying drawings.

FIG. 1 discloses aspects of a comparative approach for identifying and dealing with problems in a computing environment.

FIG. 2 discloses aspects of an approach for identifying and dealing with problems in a computing environment, according to an embodiment.

FIG. 3 discloses an example computing entity configured and operable to perform any of the disclosed methods, processes, and operations.

### DETAILED DESCRIPTION OF SOME EXAMPLE EMBODIMENTS

Embodiments of the present invention generally relate to identifying, and dealing with, vulnerabilities in containerized workload execution environments. More particularly, at least some embodiments of the invention relate to systems, hardware, software, computer-readable media, and methods, for automatically identifying system vulnerabilities, such as in containerized environments, and notifying administrators concerning those vulnerabilities, as well as identifying responsive actions, evaluating vulnerability compliance, and implementing changes to resolve identified vulnerabilities.

One example embodiment comprises a method, which may be implemented in a containerized workload environment such as Kubernetes for example, that includes, on receiving a trigger indicating that a vulnerability compliance for a system may need to be recalculated, modifying the affected system vulnerability compliance resources for the indicated system. In a reconciliation operation, a vulnerability compliance controller may detect those systems for which the vulnerability compliance is to be calculated. Next, a vulnerability compliance calculation may be initiated for affected systems using vulnerability compliance service. Finally, the vulnerability compliance calculation results may be stored in a vulnerability compliance registry.

Embodiments of the invention, such as the examples disclosed herein, may be beneficial in a variety of respects. For example, and as will be apparent from the present disclosure, one or more embodiments of the invention may provide one or more advantageous and unexpected effects, in any combination, some examples of which are set forth below. It should be noted that such effects are neither intended, nor should be construed, to limit the scope of the claimed invention in any way. It should further be noted that nothing herein should be construed as constituting an essential or indispensable element of any invention or embodiment. Rather, various aspects of the disclosed embodiments may be combined in a variety of ways so as to define yet further embodiments. For example, any element(s) of any embodiment may be combined with any element(s) of any other embodiment, to define still further embodiments. Such further embodiments are considered as being within the scope of this disclosure. As well, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

In particular, one advantageous aspect of an embodiment of the invention is that the integrity of a containerized workload environment may be preserved notwithstanding attacks or other problems. In an embodiment, an administrator may be automatically notified of a potential vulnerability, and/or of a solution to remedy the potential vulnerability. In an embodiment, a solution to a potential vulnerability may be automatically implemented. In an embodiment, a vulnerability compliance may be automatically determined. Various other advantages of one or more example embodiments will be apparent from this disclosure.

### A. Overview of Aspects of an Example Embodiment

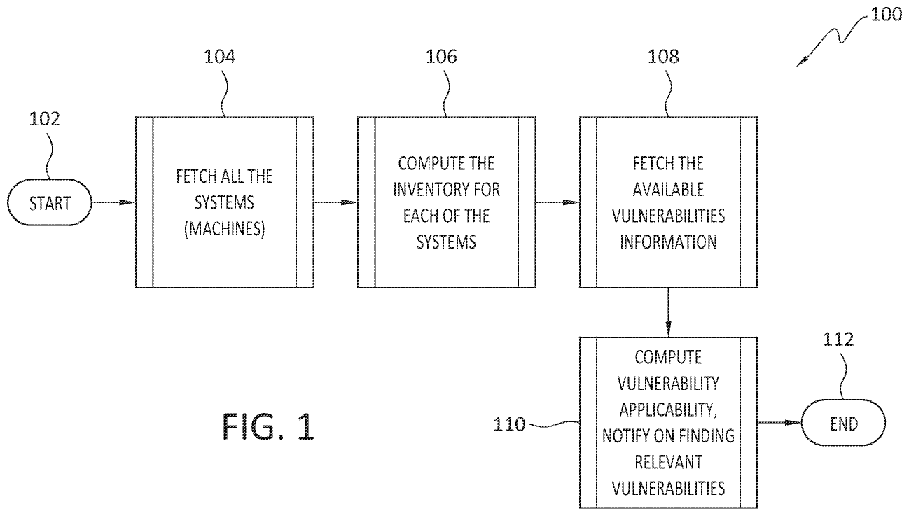

As more infrastructure providers adopt Kubernetes, for example, to manage their infrastructure, infrastructure providers need an integrated operating environment for system preparation and management tasks within Kubernetes. In most systems, there are several components that can be upgraded. System providers identify vulnerabilities and then give advice on how to manage, correct, and mitigate them. This approach is shown in the comparative example of FIG. 1.

In particular, FIG. 1 discloses an approach 100 which, after starting 102, fetches information 104 about all the systems in an environment, such as a containerized workload environment. Next, the inventory, that is, how many of the systems are present in the environment, may be computed 106 for each of the systems. When the systems have been identified, vulnerability information may then be obtained 108 for each of the systems. Finally, the applicability of the vulnerability information to each of the systems may be determined 110, and a user, such as an administrator for example, may be notified as to which systems possess which vulnerabilities. At this point, the approach 100 may terminate 112.

As noted earlier herein, this approach may be problematic for a variety of reasons. For example, this approach fails to provide a mechanism to deal with the identified vulnerabilities. Moreover, were such an approach implemented in an environment such as Kubernetes for example, the environment may not natively support identification of vulnerabilities. Further, some or all of the operations disclosed in the comparative example of FIG. 1 must be explicitly performed by a system administrator, and the indicated analyses may take a significant amount of time to perform and, insofar as they are performed by a human, are prone to error. Finally, hardware changes and system configuration changes require this, largely or completely manual, computation to be done over and over. Due to a lack of automated computation capability, this manual approach is likely to fail to identify vulnerabilities, and fail to remedy those in a timely and effective manner.

Thus, one example embodiment may comprise a custom resource schema to maintain the vulnerability compliance status of a physical system with respect to latest vulnerability management information catalog. An embodiment may comprise a custom resource for each physical system that is part of a Kubernetes cluster and for a physical system that is to be included in a Kubernetes cluster.

In an embodiment, these custom resources may be created in a declarative manner. An embodiment may comprise a vulnerability compliance trigger monitor application for listening to events that require compliance to be recalculated. Some example triggers may include (a) when new vulnerability information becomes available, (b) when any hardware component configuration changes, (c) when preparing a system for a solution, or (d) when preparing to onboard a system into the cluster.

An embodiment may comprise a vulnerability compliance trigger monitor which, on listening to an event, appropriately modifies the custom resource associated with the affected physical system or systems. On reconciliation, the vulnerability compliance controller, when it detects a difference between the desired and existing state, may invoke the vulnerability compliance service to calculate compliance, store it in the vulnerability compliance registry, and notify the system administrator. In an embodiment, the system administrator, or simply ‘administrator,’ may be a human who interacts with an architecture, examples of which are disclosed herein, by way of a user interface such as a CLI (command line interface), or GUI (graphical user interface), for example.

### B. Detailed Discussion of Aspects of an Example Embodiment

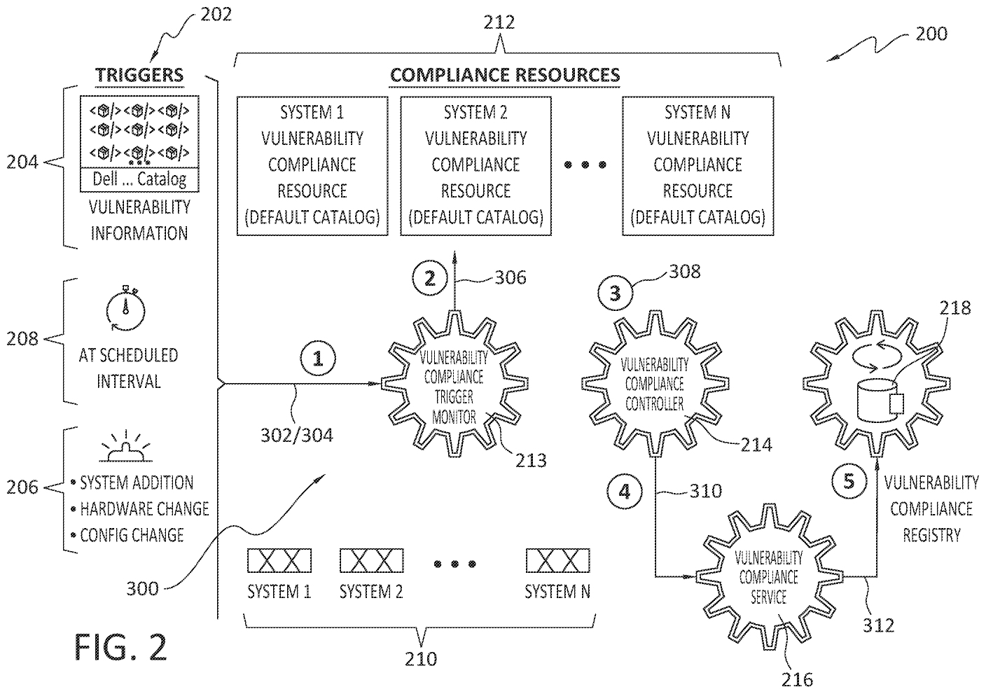

With attention now to FIG. 2, details are provided concerning aspects of an example embodiment comprising an architecture, and a method. As shown the architecture 200, which may be implemented in a containerized workload environment, may comprise various triggers 202 which, when generated, detected, and/or received, may cause the performance of various operations. The triggers 202 may be defined, for example, by an administrator, and/or by a vendor of the system(s) with which a trigger 202 is concerned. As noted earlier, some example triggers 202 may include when new vulnerability information 204 concerning a system or component of the environment becomes available, and when changes 206 occur, such as a change to a hardware component in the environment, the addition of a new/modified system to the environment, and a change to the configuration of a system or component in the environment. In an embodiment, a change 206 may comprise, for example, a change implemented by a vendor to one or more aspects of a containerized workload environment. As another example, a trigger 202 may simply comprise the passage of a defined time interval 208. Thus, even in the absence of an event such as 204 or 206, the mere passage of time may act as a trigger. It is noted that the triggers disclosed herein are presented only by way of example, and not limitation.

With continued reference to FIG. 2, the architecture 200 may include various systems 210, each of which may perform various functions relating to the environment. Because the systems 210 may vary in terms of their respective roles and functions, each of the systems 210 may be associated with a respective set of compliance resources 212 that may be listed in a catalogue specific to the system 210. A compliance resource 212 may comprise, for example, hardware, firmware, and/or software. In an embodiment, a compliance resource 212 may comprise a software update, such as for improved security for example, to a current system or component of the environment. In an embodiment, a compliance resource 212 may comprise security-related hardware such as an updated TPM (trusted platform module) chip.

As further indicated in FIG. 2, and discussed below, the example architecture 200 may comprise various other components. Such components may include, but are not limited to, a vulnerability compliance trigger monitor (VCTM) 213, a vulnerability compliance controller (VCC) 214, a vulnerability compliance service (VCS) 216, and a vulnerability compliance registry (VCR) 218.

In an embodiment, a method 300 may be implemented in the architecture 200. The method 300 may begin with the monitoring 302 of one or more of the systems 210 for vulnerability compliance, that is, compliance with established hardware, firmware, and/or software, standards or procedures, for example, relating to the vulnerability and/or potential vulnerability of the systems 210 to malicious attacks and/or malware.

At some point during the monitoring 302, the VCTM 213 may receive 304 a trigger indicating a need to modify one or more compliance resources 212 of one of the systems 210. In an embodiment, the trigger may be self-generated by a system 210, or may be generated externally to the system 210. In one example, installation of a new component in the architecture 200 may automatically generate a trigger. Other example events that may cause the generation of a trigger are discussed elsewhere herein.

Upon receipt 304 of a trigger, the VCTM 213 may then parse the trigger and, based on the parsing, modify 306 the vulnerability compliance resources for the system 210 indicated by the trigger. In an embodiment, the modifying 306 may comprise updating, possibly automatically after receipt 304 of the trigger 202, a catalogue that lists the vulnerability compliance resources for that system 210.

The modifying 306 may also comprise implementing, possibly automatically after updating of the catalogue, changes to the vulnerability compliance resources deployed at the system 210. For example, a hardware, software, or firmware, update may be made to the system 210. In the case of a software or firmware update, for example, the change may be implemented automatically, and the catalogue of vulnerability compliance resources for the affected system 210 may be correspondingly updated to indicate the change. In the case of a hardware update, a system administrator may be notified that a hardware change is needed to the system 210, and the catalogue then be updated after the hardware change has been made.

At some point, possibly before, and/or after, the operations 302-306, a reconciliation operation 308 may be performed. As part of the reconciliation operation 308, the VCC 214 may detect the system(s) 210 for which a respective vulnerability compliance is to be calculated. In an embodiment, the reconciliation operation 308 may be performed on an individual basis for one or more systems 210, and/or on an aggregate basis for multiple systems 210. The latter case may be applied where, for example, two or more systems 210 are related in their operation such that a vulnerability of one system 210 implies a vulnerability of another of the systems 210.

After detecting, possibly as part of 308, the system(s) 210 for which a respective vulnerability compliance is to be calculated, the VCC 214 may initiate 310 calculation of a vulnerability compliance score by the VCS 216. The vulnerability compliance score, which may comprise a numerical score, such as on a scale of 1 to 10, for a system 210 may indicate an extent to which the system 210 is (10 is worst), or is not (1 is best), vulnerable to an attack or other problem. In an embodiment, the vulnerability compliance score may result in a system 210 being designated as ‘compliant’ or ‘not compliant.’ The components of a system may be weighted so that, for example, a component relatively more vulnerable to problems may be given a higher weight than a component that is relatively less vulnerable to problems. The weighted scores for the components, which may be hardware, software, and/or firmware, may be aggregated together to generate the vulnerability compliance score. Note that embodiments are not limited to dealing with vulnerabilities in the form of attacks and malware. In an embodiment a vulnerability may comprise a vulnerability to problems, such as poor or slow performance, simply due to outdated software, firmware, and/or hardware.

After the vulnerability compliance score has been calculated by the VCS 216, the vulnerability compliance score may be stored 312 by the VCS 216 in the VCR 218. in an embodiment, the VCR 218 may comprise, or be stored in, a database. The vulnerability compliance of an asset such as a system 210, or systems 210, and/or the entire architecture 200, may be tracked over time, and trend analyses and other evaluations and analyses performed based on the historical vulnerability compliance information.

### C. Example Methods

It is noted with respect to the disclosed methods, including the example method of FIG. 2, that any operation(s) of any of these methods, may be performed in response to, as a result of, and/or, based upon, the performance of any preceding operation(s). Correspondingly, performance of one or more operations, for example, may be a predicate or trigger to subsequent performance of one or more additional operations. Thus, for example, the various operations that may make up a method may be linked together or otherwise associated with each other by way of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

### D. Further Discussion

As apparent from this disclosure, one or more embodiments may comprise various useful features and aspects, although no embodiment is required to include any of such features and aspects. Following are some examples. An embodiment may make the vulnerability compliance analysis results instantly available in a containerized workload environment, such as a Kubernetes environment for example. An embodiment may instantly notify administrators about the known vulnerabilities in a containerized workload environment. An embodiment may identify the actions required to be taken to make systems safe, or relatively less vulnerable, in a containerized workload environment. An embodiment may facilitate the ability of the infrastructure provider to keep the environment safe. Finally, an embodiment may enable a systems administrator to identify the actions required to be taken to safeguard the environment.

### E. Further Example Embodiments

Following are some further example embodiments of the invention. These are presented only by way of example and are not intended to limit the scope of the invention in any way.

Embodiment 1. A method, comprising: monitoring a containerized workload environment; receiving, as a result of the monitoring, a trigger indicating that a system in the containerized workload environment should be modified to address a vulnerability of the system; as a result of the trigger, updating a vulnerability compliance resource catalogue, associated with the system, to list an update that is needed to address the vulnerability; implementing the update in the system; performing a reconciliation that comprises identifying the system as needing a vulnerability compliance calculation; and performing the vulnerability compliance calculation for the system and generating, based on the performing, a vulnerability compliance score for the system.

Embodiment 2. The method as recited in any preceding embodiment, wherein the update comprises any one or more of: a software update; a hardware update; or a firmware update.

Embodiment 3. The method as recited in any preceding embodiment, wherein the update is implemented automatically after receipt of the trigger.

Embodiment 4. The method as recited in any preceding embodiment, wherein the trigger is generated in response to one of: passage of a defined time interval; an addition or change to the system; or a change in the containerized workload environment.

Embodiment 5. The method as recited in any preceding embodiment, wherein the vulnerability compliance score indicates an extent to which the system is in compliance with an established standard.

Embodiment 6. The method as recited in any preceding embodiment, wherein the vulnerability comprises vulnerability to an attack or malware.

Embodiment 7. The method as recited in any preceding embodiment, wherein an administrator is notified automatically when the trigger is received.

Embodiment 8. The method as recited in any preceding embodiment, wherein the update comprises a vulnerability compliance resource.

Embodiment 9. The method as recited in any preceding embodiment, wherein the containerized workload environment comprises a Kubernetes environment.

Embodiment 10. The method as recited in any preceding embodiment, wherein results of the vulnerability compliance calculation are stored in a vulnerability compliance registry for the containerized workload environment.

Embodiment 11. A system, comprising hardware and/or software, operable to perform any of the operations, methods, or processes, or any portion of any of these, disclosed herein.

Embodiment 12. A non-transitory storage medium having stored therein instructions that are executable by one or more hardware processors to perform operations comprising the operations of any one or more of embodiments 1-10.

### F. Example Computing Devices and Associated Media

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of the present invention also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality of the invention. Combinations of the above should also be included within the scope of computer storage media. Such media are also examples of non-transitory storage media, and non-transitory storage media also embraces cloud-based storage systems and structures, although the scope of the invention is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments of the invention may be downloadable to one or more systems or devices, for example, from a website, mesh topology, or other source. As well, the scope of the invention embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term ‘module’ or ‘component’ may refer to software objects or routines that execute on the computing system. The different components, modules, engines, and services described herein may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments of the invention may be performed in client-server environments, whether network or local environments, or in any other suitable environment. Suitable operating environments for at least some embodiments of the invention include cloud computing environments where one or more of a client, server, or other machine may reside and operate in a cloud environment.

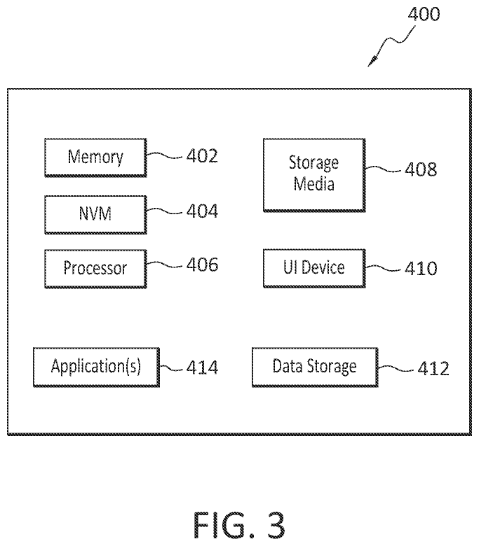

With reference briefly now to FIG. 3, any one or more of the entities disclosed, or implied, by FIGS. 1-2, and/or elsewhere herein, may take the form of, or include, or be implemented on, or hosted by, a physical computing device, one example of which is denoted at 400. As well, where any of the aforementioned elements comprise or consist of a virtual machine (VM), that VM may constitute a virtualization of any combination of the physical components disclosed in FIG. 3.

In the example of FIG. 3, the physical computing device 400 includes a memory 402 which may include one, some, or all, of random access memory (RAM), non-volatile memory (NVM) 404 such as NVRAM for example, read-only memory (ROM), and persistent memory, one or more hardware processors 406, non-transitory storage media 408, UI device 410, and data storage 412. One or more of the memory components 402 of the physical computing device 400 may take the form of solid state device (SSD) storage. As well, one or more applications 414 may be provided that comprise instructions executable by one or more hardware processors 406 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method, comprising:
monitoring a containerized workload environment;
receiving, as a result of the monitoring, a trigger indicating that a system in the containerized workload environment should be modified to address a vulnerability of the system;
as a result of the trigger, updating a vulnerability compliance resource catalogue, associated with the system, to list an update that is needed to address the vulnerability;
implementing the update in the system;
performing a reconciliation that comprises identifying the system as needing a vulnerability compliance calculation; and
performing the vulnerability compliance calculation for the system and generating, based on the performing, a vulnerability compliance score for the system.

2. The method as recited in claim 1, wherein the update comprises any one or more of: a software update; a hardware update; or a firmware update.

3. The method as recited in claim 1, wherein the update is implemented automatically after receipt of the trigger.

4. The method as recited in claim 1, wherein the trigger is generated in response to one of: passage of a defined time interval; an addition or change to the system; or a change in the containerized workload environment.

5. The method as recited in claim 1, wherein the vulnerability compliance score indicates an extent to which the system is in compliance with an established standard.

6. The method as recited in claim 1, wherein the vulnerability comprises vulnerability to an attack or malware.

7. The method as recited in claim 1, wherein an administrator is notified automatically when the trigger is received.

8. The method as recited in claim 1, wherein the update comprises a vulnerability compliance resource.

9. The method as recited in claim 1, wherein the containerized workload environment comprises a Kubernetes environment.

10. The method as recited in claim 1, wherein results of the vulnerability compliance calculation are stored in a vulnerability compliance registry for the containerized workload environment.

11. A non-transitory storage medium having stored therein instructions that are executable by one or more hardware processors to perform operations comprising:
monitoring a containerized workload environment;
receiving, as a result of the monitoring, a trigger indicating that a system in the containerized workload environment should be modified to address a vulnerability of the system;
as a result of the trigger, updating a vulnerability compliance resource catalogue, associated with the system, to list an update that is needed to address the vulnerability;
implementing the update in the system;
performing a reconciliation that comprises identifying the system as needing a vulnerability compliance calculation; and
performing the vulnerability compliance calculation for the system and generating, based on the performing, a vulnerability compliance score for the system.

12. The non-transitory storage medium as recited in claim 11, wherein the update comprises any one or more of: a software update; a hardware update; or a firmware update.

13. The non-transitory storage medium as recited in claim 11, wherein the update is implemented automatically after receipt of the trigger.

14. The non-transitory storage medium as recited in claim 11, wherein the trigger is generated in response to one of: passage of a defined time interval; an addition or change to the system; or a change in the containerized workload environment.

15. The non-transitory storage medium as recited in claim 11, wherein the vulnerability compliance score indicates an extent to which the system is in compliance with an established standard.

16. The non-transitory storage medium as recited in claim 11, wherein the vulnerability comprises vulnerability to an attack or malware.

17. The non-transitory storage medium as recited in claim 11, wherein an administrator is notified automatically when the trigger is received.

18. The non-transitory storage medium as recited in claim 11, wherein the update comprises a vulnerability compliance resource.

19. The non-transitory storage medium as recited in claim 11, wherein the containerized workload environment comprises a Kubernetes environment.

20. The non-transitory storage medium as recited in claim 11, wherein results of the vulnerability compliance calculation are stored in a vulnerability compliance registry for the containerized workload environment.
